(19) United States
(12) Patent Application Publication
(10) Pub. No.: US 2014/0218410 A1
(43) Pub. Date: Aug. 7, 2014

(54) System And Method For Efficiently Generating Device-Dependent Anaglyph Images

(71) Applicants: Sirui Hu, West Lafayette, IN (US); Alexander Berestov, San Jose, CA (US); Jianing Wei, San Jose, CA (US)

(72) Inventors: Sirui Hu, West Lafayette, IN (US); Alexander Berestov, San Jose, CA (US); Jianing Wei, San Jose, CA (US)

(21) Appl. No.: 13/759,294

(22) Filed: Feb. 5, 2013

(51) Int. Cl. G06T 15/00

(52) U.S. Cl. CPC G06T 15/00
USPC 345/690; 345/204

(57) ABSTRACT

A system for efficiently generating device-dependent anaglyph images includes a display device for presenting anaglyph images in a three-dimensional format. An anaglyph converter includes a conversion manager that interacts with system users to perform configuration procedures for generating anaglyph images. The configuration procedures are utilized to define one or more imaging parameters that are dependent upon imaging characteristics of said display device. The imaging parameters may include ghosting reduction parameters and color adjustment parameters. A processor device typically controls the conversion manager to perform the anaglyph image generation procedures.

### BACKGROUND SECTION

1. Field of the Invention

This invention relates generally to techniques for displaying stereoscopic 3D image data, and relates more particularly to a system and method for efficiently generating device-dependent anaglyph 3D images.

2. Description of the Background Art

Implementing effective methods for displaying image data is a significant consideration for designers and manufacturers of contemporary electronic systems. However, effectively displaying image data may create substantial challenges for system designers. For example, enhanced demands for increased device functionality and performance may require more system processing power and require additional software resources. An increase in processing or software requirements may also result in a corresponding detrimental economic impact due to increased production costs and operational inefficiencies.

Furthermore, enhanced device capability to perform various advanced functions may not only provide additional benefits to a system user, for example provide the user with better viewing experience by extending 2D viewing to 3D, but may also place increased demands on the control and management of various system components. For example, an enhanced electronic device that effectively supports three-dimensional images may benefit from an effective implementation because of the large amount and complexity of the digital data involved.

Due to growing demands on system resources and substantially increasing data magnitudes, it is apparent that developing new techniques for displaying image data is a matter of concern for related electronic technologies. Therefore, for all the foregoing reasons, developing effective techniques for displaying image data remains a significant consideration for designers, manufacturers, and users of contemporary electronic devices.

### SUMMARY

In accordance with the present invention, a system and method for efficiently generating device-dependent anaglyph images are disclosed. In one embodiment of an off-line anaglyph configuration procedure, a system user may utilize a display-type GUI to affirmatively identify the particular display type for displaying 3D anaglyph images. This display type information may be utilized to associate the particular display with corresponding display characteristics such as a display spectrum. The display characteristics may then be utilized to derive appropriate transformation matrices for performing a 3D anaglyph image generation procedure.

In certain embodiments of the configuration procedure, a system user may also utilize a ghosting reduction GUI to select one or more ghosting reduction parameters for the 3D anaglyph images by adjusting a ghosting test pattern. This information may be utilized to minimize ghosting artifacts in 3D anaglyph images. In certain embodiments of the configuration procedure, a system user may further utilize a color adjustment GUI to select one or more color adjustment parameters for the 3D anaglyph images by adjusting a color image in conjunction with the ghosting test pattern. This information may be utilized to optimize color characteristics in 3D anaglyph images.

In one embodiment of an on-line anaglyph image generation procedure, a conversion manager of an anaglyph generator initially accesses the left image in an input stereo pair in rgb color space. The input left image has reverse gamma correction applied to produce an uncorrected left image. The uncorrected left image is then processed with a left transform matrix that is derived from the foregoing offline configuration procedure depending upon selected characteristics of the particular display. The resultant transformed left image then has a left clipping procedure applied in any appropriate manner to produce a clipped left image. For example, if the range of pixel values is selected to be from zero to 255, then the clipping procedure may remove any values that exceed the predetermined range.

In a parallel manner, the conversion manager similarly accesses the right image in an input stereo pair in rgb color space. The input right image has reverse gamma correction applied to produce an uncorrected right image. The uncorrected right image is then processed with a right transform matrix that is derived in the foregoing offline configuration procedure depending upon selected characteristics of the particular display. The resultant transformed right image then has a right clipping procedure applied in any appropriate manner to produce a clipped right image. For example, if the range of pixel values is selected to be from zero to 255, then the clipping procedure may remove any values that exceed the predetermined range.

Next, the foregoing clipped right image and clipped left image are combined to produce an initial anaglyph image. The conversion manager may perform a ghosting reduction procedure on the initial anaglyph image according to one or more ghosting parameters that have been previously defined in any appropriate manner. For example, a system user may empirically define specific ghosting parameter(s) when viewing a ghosting test pattern while adjusting the ghosting parameter(s) to obtain a minimal amount of ghosting artifacts.

Similarly, the conversion manager may perform a color adjustment procedure on the initial anaglyph image according to one or more color parameters that have been previously defined in any appropriate manner. For example, a system user may empirically define specific color parameter(s) when viewing a color scene in conjunction with the ghosting test pattern while adjusting the color parameter(s) to obtain an optimal tradeoff between ghosting artifacts and color characteristics.

Next, the initial anaglyph image may have gamma correction applied to produce a corrected anaglyph image. The resultant corrected anaglyph image may then have an anaglyph clipping procedure applied in any appropriate manner to produce a final anaglyph image. For example, if the range of pixel values is selected to be from zero to 255, then the clipping procedure may remove any values that exceed the predetermined range. The final anaglyph image may then be viewed through 3D anaglyph glasses on the display. For at least the foregoing reasons, the present invention therefore provides an improved system and method for efficiently generating device-dependent anaglyph images.

### BRIEF DESCRIPTION OF THE DRAWINGS

FIG. 1 is a block diagram of an electronic system, in accordance with one embodiment of the present invention;

FIG. 2 is a block diagram for one embodiment of the anaglyph converter of FIG. 1, in accordance with the present invention;

FIG. 3 is a block diagram for one embodiment of the memory of FIG. 2, in accordance with the present invention;

FIG. 4 is a flowchart of method steps for performing an anaglyph configuration procedure, in accordance with one embodiment of the present invention;

FIG. 5 is a diagram of a display screen for identifying a display type, in accordance with one embodiment the present invention;

FIG. 6A is a diagram that depict a basic anaglyph image generation procedure, in accordance with one embodiment of the present invention;

FIG. 6B is a diagram that depicts an enhanced clipping procedure for generating anaglyph images, in accordance with one embodiment of the present invention;

FIG. 7 is a diagram of a display screen for performing a ghosting reduction procedure, in accordance with one embodiment the present invention;

FIG. 8 is a diagram of a display screen for performing a color adjustment procedure, in accordance with one embodiment the present invention; and

FIGS. 9A and 9B are a flowchart of method steps for performing an anaglyph image generation procedure, in accordance with one embodiment of the present invention.

### DETAILED DESCRIPTION

The present invention relates to an improvement in image display techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Therefore, the present invention is not intended to be limited to the embodiments shown, but is to be accorded the widest scope consistent with the principles and features described herein.

The present invention comprises a system and method for efficiently generating device-dependent anaglyph images, and includes a display device for presenting anaglyph images in a three-dimensional format. An anaglyph converter includes a conversion manager that interacts with system users to perform configuration procedures for generating anaglyph images. The configuration procedures are utilized to define one or more imaging parameters that are dependent upon imaging characteristics of said display device. The imaging parameters may include ghosting reduction parameters and color adjustment parameters. A processor device typically controls the conversion manager to perform the anaglyph image generation procedures.

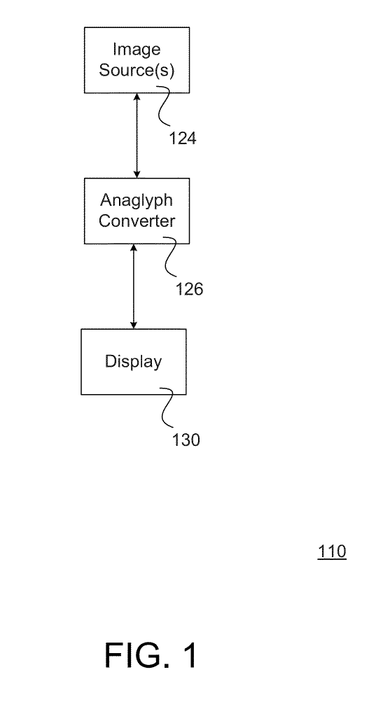

Referring now to FIG. 1, a block diagram of an electronic system 110 is shown, in accordance with one embodiment of the present invention. In the FIG. 1 embodiment, electronic system 110 may include, but is not limited to, one or more image sources 124, an anaglyph converter 126, and a display 130. In alternate embodiments, electronic system 110 may be implemented by utilizing components and configurations in addition to, or instead of, certain of those components and configurations discussed in conjunction with the FIG. 1 embodiment.

Anaglyph 3D is the name given to a stereoscopic 3D (3-dimensional) effect achieved by means of encoding each eye's image using filters of different (usually chromatically opposite) colors, typically red and cyan. Anaglyph 3D images contain two differently filtered colored images, one for each eye. When viewed through the filtering anaglyph glasses, each of the two images reaches one eye, revealing an integrated stereoscopic image. The visual cortex of the brain fuses this into perception of a three dimensional scene or composition.

Anaglyph is a simple method for 3D visualization with low cost, without the need of an expensive 3D display. Ghosting effects have to be reduced to improve anaglyph quality and visual comfort. This invention provides a ghost-reduction workflow designed to provide an improved anaglyph algorithm that is adjustable according to individual display devices and user viewing preferences.

In the FIG. 1 embodiment, one or more image sources 124 provide initial left and right source input images in any appropriate format. Image sources 124 may include, but are not limited to, a still image source and a video source. Furthermore, image sources 124 may be local or remote (accessed through a network such as the Internet).

In the FIG. 1 embodiment, anaglyph converter 126 may receive the input images and responsively process the input images to produce an integrated anaglyph image that may be viewed on display 130 through 3D glasses. The FIG. 1 anaglyph converter 126 is shown as a discrete device. In alternate embodiments, anaglyph converter 126 may also be implemented as an integral part of display 130 or one or more image source devices 124.

In the FIG. 1 embodiment, display 130 may be implemented in any effective manner. For example, display 130 may be implemented as a television, a computer monitor, a cellular telephone, a personal digital assistant, or a consumer electronics device. In accordance with certain embodiments of the present invention, display 130 may be economically implemented without 3D display capabilities. The utilization of anaglyph converter 126 thus allows a device user to enjoy a 3D viewing experience without having to purchase an expensive new 3D television.

Ghosting and color fidelity are two key issues of anaglyph quality. Ghosting is manifested by blurring and doubling of edges in a given image. Ghosting may be especially severe when displaying images on a TV after image enhancement. Ghosting is display type dependent, display spectrum dependent, display setting dependent, and image content dependent. The present invention improves the 3D quality of anaglyph images/videos, taking device dependent factors into account.

In accordance with the present invention, a workflow is designed to collect selectable parameters for ghosting reduction and color improvement on an individual display by utilizing user input in response to easy-to-follow instructions. Users will be asked to configure the anaglyph algorithm parameters when they first use it on a new display device or in a new display environment.

Users will first select the type of display being used, and then adjust a sliding bar until a test pattern has minimum ghosting. For example, a user may adjust a saturation parameter in Hue-Saturation-Intensity (HSI) color space. The user may also adjust another sliding bar while viewing both the test pattern and a natural photo to obtain an optimal trade-off between ghosting and color quality. For example, the user may adjust an intensity parameter in HSI color space.

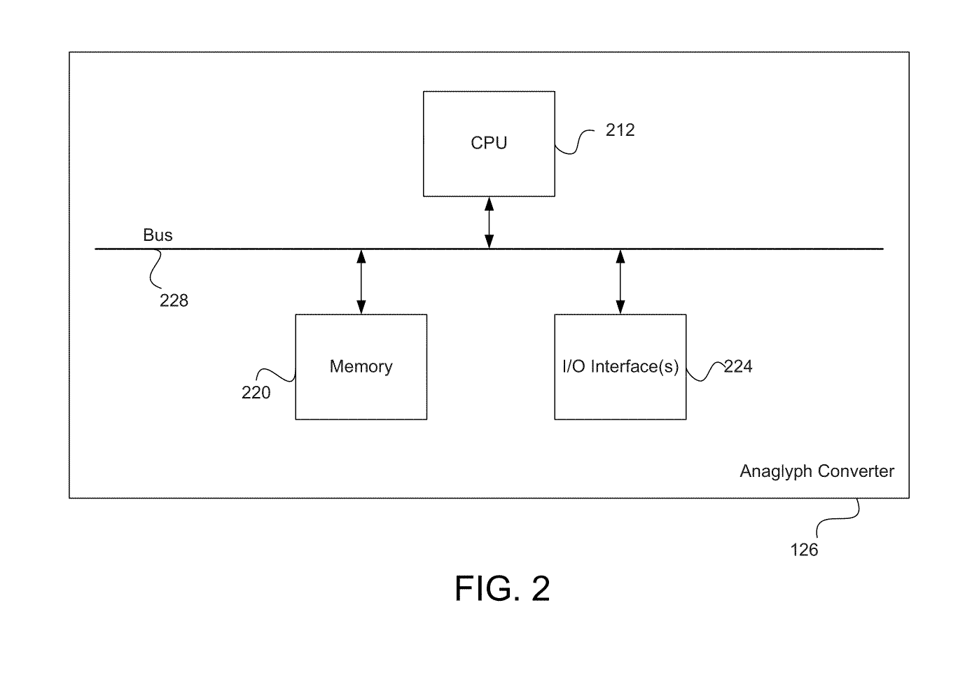

After configuration, these user-selected device-dependent parameters may be applied to the anaglyph generation algorithm, so that the output anaglyph images/videos will be optimized in terms of both ghosting and color reproduction for a particular display. Additional details regarding the implementation and utilization of anaglyph converter 126 are further discussed below in conjunction with FIGS. 2-9

Referring now to FIG. 2, a block diagram for one embodiment of the FIG. 1 anaglyph converter 126 is shown, in accordance with the present invention. In the FIG. 2 embodiment, anaglyph converter 126 includes, but is not limited to, a central processing unit (server CPU) 212, a memory 220, and one or more input/output interface(s) (server I/O interface(s)) 224. The foregoing components of anaglyph converter 126 may be coupled to, and communicate through, a bus 228. In alternate embodiments, anaglyph converter 126 may be implemented using components and configurations in addition to, or instead of, certain of those components and configurations discussed in conjunction with the FIG. 2 embodiment.

Furthermore, in the FIG. 2 embodiment, anaglyph converter 126 may be implemented either as a separate stand-alone device, or as an integral part of any type of appropriate entity. For example, in certain embodiments, anaglyph converter 126 may be implemented in any type of stationary or portable electronic device, such as a personal computer, a television, a consumer-electronics device, a cellular telephone, a set-top box, an audio-visual entertainment device, or a personal digital assistant (PDA).

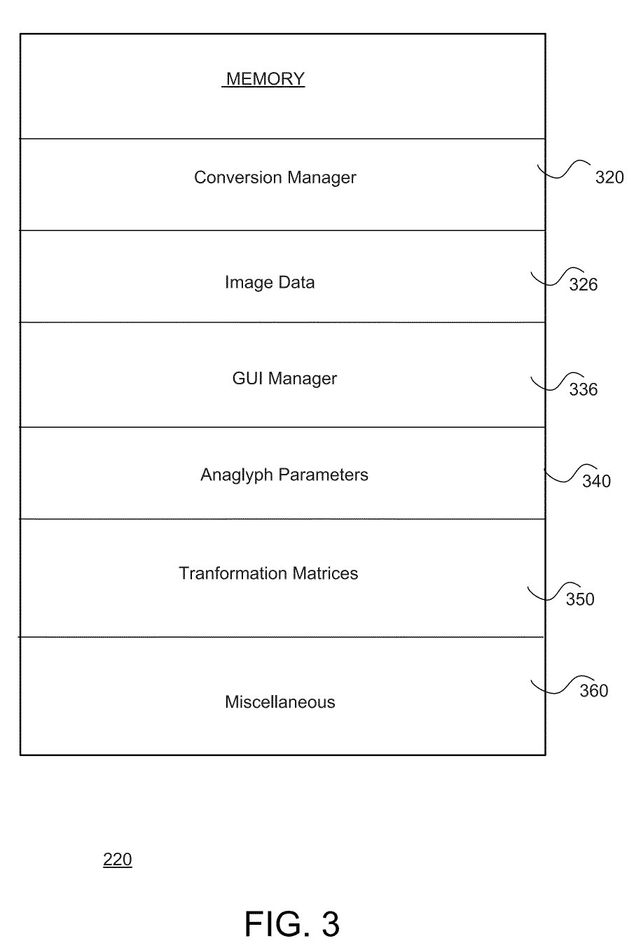

In the FIG. 2 embodiment, CPU 212 may be implemented to include any appropriate and compatible microprocessor device that executes software instructions to thereby control and manage the operation of anaglyph converter 126. In the FIG. 2 embodiment, memory 220 may be implemented to include any combination of desired storage devices, including, but not limited to, read-only memory (ROM), random-access memory (RAM), and various types of non-volatile memory, such as floppy disks, memory sticks, compact disks, or hard disks. The contents and functionality of memory 220 are further discussed below in conjunction with FIG. 3.

In the FIG. 2 embodiment, I/O interface(s) 224 may include one or more input and/or output interfaces to receive and/or transmit any required types of information by anaglyph converter 126. I/O interface(s) 224 may include one or more means for allowing a device user to communicate with anaglyph converter 126. The implementation and utilization of anaglyph converter 126 is further discussed below in conjunction with FIGS. 3-9.

Referring now to FIG. 3, a block diagram for one embodiment of the FIG. 2 memory 220 is shown, in accordance with the present invention. In the FIG. 3 embodiment, memory 220 may include, but is not limited to, a conversion manager 320, image data 326, a graphical-user-interface (GUI) manager 336, anaglyph parameters 340, one or more transformation matrices 350, and miscellaneous information 360. In alternate embodiments, memory 220 may include various other components and functionalities in addition to, or instead of, certain those components and functionalities discussed in conjunction with the FIG. 3 embodiment.

In the FIG. 3 embodiment, conversion manager 320 may include program instructions that are preferably executed by CPU 212 (FIG. 2) to perform various functions and operations for anaglyph converter 126. For example, conversion manager 320 may include any effective means for configuring or performing anaglyph image generation procedures. In the FIG. 3 embodiment, image data 336 may include any type of information for input, processing, or output by anaglyph converter 126.

In the FIG. 3 embodiment, GUI manager 336 may perform appropriate display functions for supporting the present invention. In the FIG. 3 embodiment, anaglyph parameters 340 may be selected by device users to optimize 3D anaglyph images, according to the present invention. In the FIG. 3 embodiment, transformation matrices 350 may be utilized to convert input stereo image pairs into 3D anaglyph images, in accordance with the present invention. Miscellaneous information 360 may include any additional information for utilization by anaglyph converter 126.

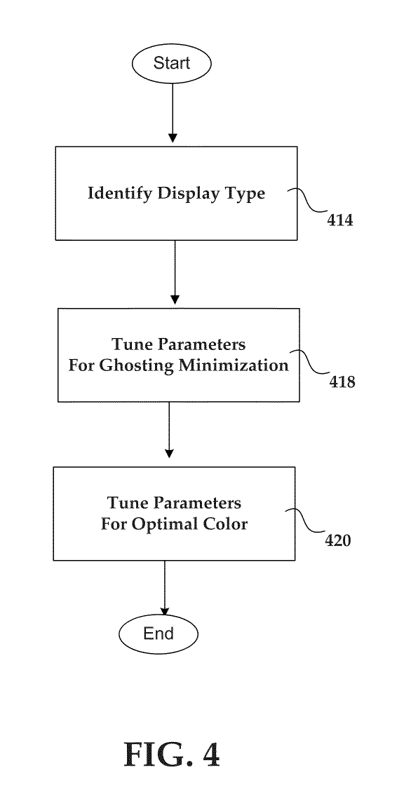

In the FIG. 3 embodiment, the present invention is disclosed and discussed as being implemented primarily as software. However, in alternate embodiments, some or all of the functions of the present invention may be performed by appropriate electronic hardware circuits that are configured for performing various functions that are equivalent to those functions of the software modules discussed herein. Additional details regarding the operation and implementation of anaglyph converter 126 are further discussed below in conjunction with FIGS. 4 through 9.

Referring now to FIG. 4, a flowchart of method steps for performing an anaglyph configuration procedure is shown, in accordance with the present invention. The FIG. 4 embodiment is presented for purposes of illustration, and in alternate embodiments, the present invention may configure anaglyph configuration procedures using techniques in addition to, or instead of, certain of those techniques discussed in conjunction with the FIG. 4 embodiment.

In step 414 of the FIG. 4 embodiment, a system user may utilize a device-type GUI on a display screen to affirmatively identify the particular display type for displaying 3D anaglyph images. This information may be utilized to associate the display with corresponding display characteristics such as a display spectrum. The display characteristics may then be utilized to derive appropriate transformation matrices for performing a 3D anaglyph image generation procedure.

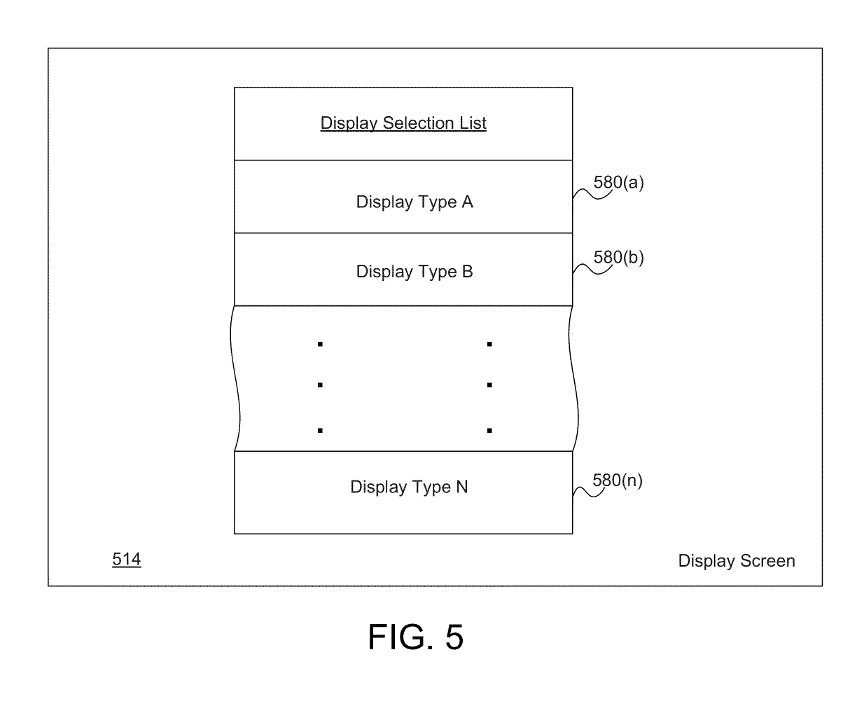

In step 418 of the FIG. 4 embodiment, a system user may utilize a ghosting reduction GUI on the display screen to select one or more ghosting reduction parameters for the 3D anaglyph images by adjusting a ghosting test pattern. This information may be utilized to minimize ghosting artifacts in 3D anaglyph images. Finally, in step 420 of the FIG. 4 embodiment, a system user may utilize a color adjustment GUI on the display screen to select one or more color adjustment parameters for the 3D anaglyph images by adjusting a color natural image in conjunction with the ghosting test pattern. This information may be utilized to minimize color infidelity in 3D anaglyph images. Additional details regarding the generation of anaglyph images are further discussed below in conjunction with FIGS. 5-9.

Referring now to FIG. 5, a diagram of a display screen 514 for identifying a display type is shown, in accordance with one embodiment the present invention. In alternate embodiments, the present invention may identify display types by utilizing techniques and configurations in addition to, or instead of, certain of those techniques and configurations discussed in conjunction with the FIG. 5 embodiment. The FIG. 5 display screen 514 may correspond to certain embodiments of step 414 of FIG. 4.

In the FIG. 5 embodiment, display screen 514 provides a display-type GUI which includes a series of different possible display types 580. The system user may utilize the display-type GUI to identify a specific display type for a particular display 130. This display-type information may be utilized to associate the display with corresponding display characteristics such as a display spectrum. The display characteristics may then be utilized to derive appropriate transformation matrices for performing a 3D anaglyph image generation procedure.

In certain embodiments, an appropriate anaglyph image generation method may be chosen depending upon which method works best for a given display. For example, a standard or enhanced photoshop method or Wimmer method may be selected. In other embodiments, an appropriate anaglyph image generation method may be chosen depending upon the display spectrum of a given display. For example, a standard or enhanced Dubois method or McAllister method may be selected.

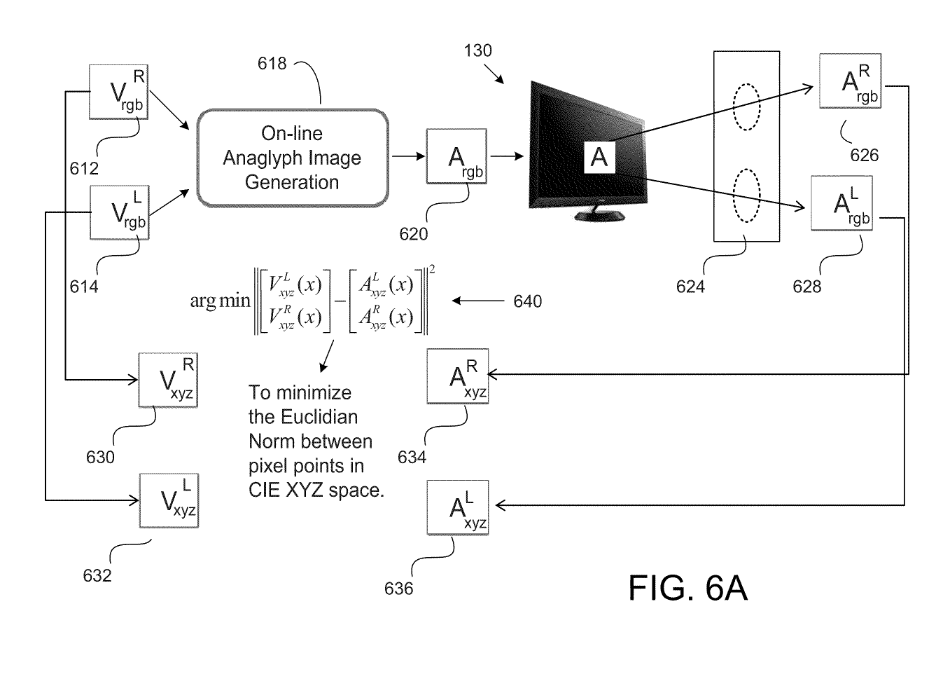

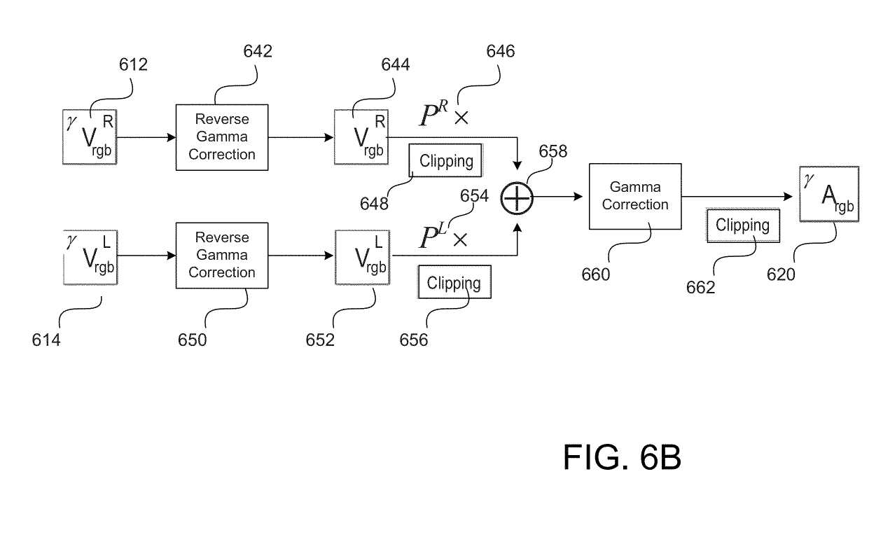

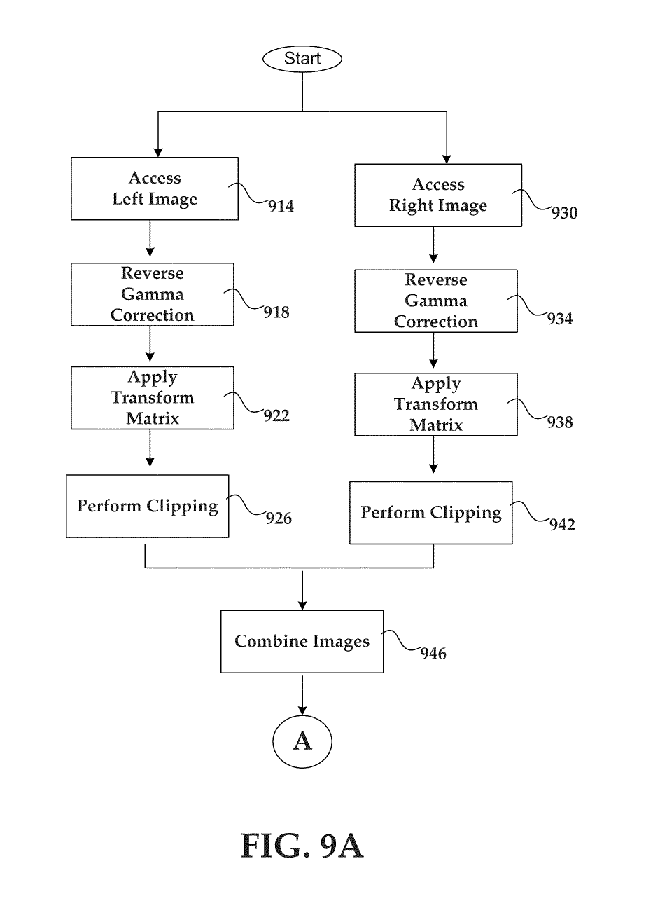

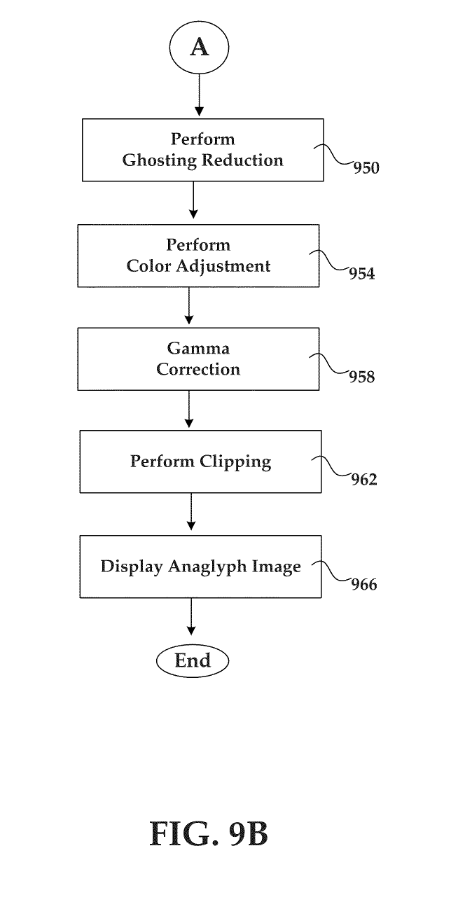

In various embodiments of the present invention, anaglyph converter 126 may be notified of the display type in any effective manner. For example, a system user may utilize an input device such as a keyboard, touchscreen, or remote control to make a selection. Similarly, converter 126 may determine the appropriate display characteristics in any appropriate manner including, but not limited to, a look-up table, database, or Internet resource. The utilization of display-type information is further discussed below in conjunction with FIGS. 6 and 9.

Referring now to FIG. 6A, a diagram depicting a basic anaglyph image generation procedure is shown, in accordance with one embodiment of the present invention. The FIG. 6A embodiment is presented for purposes of illustration, and in alternate embodiments, the present invention may generate anaglyph images using techniques in addition to, or instead of, certain of those techniques discussed in conjunction with the FIG. 6A embodiment.

In discussion of the present invention, certain notations are utilized herein as follows. The notation x represents the index of a pixel location in an image. Super-script plus a capital letter denotes Left and Right. For example, V^{L} is the left image of an input stereo pair, V^{R} is the right image of an input stereo pair, A is the anaglyph image to be displayed, A^{L} is the anaglyph image after red filter (perceived in the left eye), and A^{R} is the anaglyph image after cyan filter (perceived in the right eye). Sub-script plus lower case denotes color space. The examples below indicate the pixel value of the left image of an input stereo pair in rgb color space and in xyz color space.

In the FIG. 6A embodiment, a right image of the input stereo pair 612 and a left image of the input stereo pair 614 in rgb color space are received and processed in an anaglyph image generation procedure 618 to produce an anaglyph image 620 in rgb color space that is then displayed on display 130. Anaglyph image 620 may be filtered through 3D glasses 624 to produce a perceived right anaglyph image 626 and a perceived left anaglyph image 628 in rgb color space.

In certain embodiments, right anaglyph image 626 and left anaglyph image 628 may be converted to a right anaglyph image 634 and a left anaglyph image 636 in xyz color space. Similarly, the left image of an input stereo pair 612 and the right image of an input stereo pair 614 may be converted into a right stereo pair image 630 and a left stereo pair image 632 in xyz color space. In order to determine appropriate transformation matrices for performing the anaglyph image generation procedure 618, a formula 640 may then be utilized to minimize the Euclidian distance in CIE XYZ color space between corresponding pixels points in image 630 and image 634, as well as in image 632 and image 636.

Further information regarding performing anaglyph image generation procedures may be found in “A projection method to generate anaglyph stereo images”, by E. Dubois, published in Proceedings of the IEEE International Conference on Acoustics, Speech, and Signal Processing (2001), vol. 3, pp. 1661-1664. Additional details regarding the generation of anaglyph images are further discussed below in conjunction with FIGS. 6B-9B.

Referring now to FIG. 6B a diagram depicting an enhanced clipping procedure for generating anaglyph images is shown, in accordance with one embodiment of the present invention. The FIG. 6B embodiment is presented for purposes of illustration, and in alternate embodiments, the present invention may perform clipping procedures using techniques in addition to, or instead of, certain of those techniques discussed in conjunction with the FIG. 6B embodiment.

The FIG. 6B embodiment may represent an enhanced technique for performing the anaglyph image generation procedure 618 of foregoing FIG. 6A. In FIG. 6B embodiment, a right input image 612 has reverse gamma correction 642 applied to produce an uncorrected right image 644 that is then processed with a right transform matrix 646 that is selected depending upon characteristics of the particular display 130. The resultant transformed right image then has a right clipping procedure 648 applied in any appropriate manner to produce a clipped right image. For example, if the range of pixel values is selected to be from zero to 255, then the clipping procedure may remove any values that exceed the predetermined range.

In FIG. 6B embodiment, a left input image 614 has reverse gamma correction 650 applied to produce an uncorrected left image 652 that is then processed with a left transform matrix 654 that is selected depending upon characteristics of the particular display 130. The resultant transformed left image then has a left clipping procedure 652 applied in any appropriate manner to produce a clipped left image. For example, if the range of pixel values is selected to be from zero to 255, then the clipping procedure may remove any values that exceed the predetermined range.

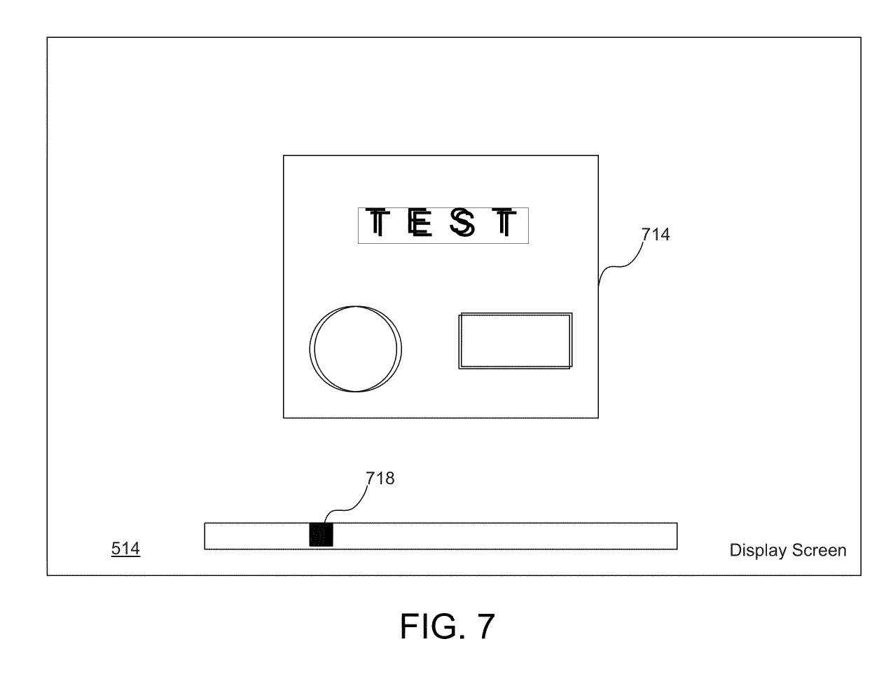

In the FIG. 6B embodiment, the clipped right image and the clipped left image may be combined at combination node 658 to produce an initial anaglyph image that has gamma correction 660 applied to produce a corrected anaglyph image. In the FIG. 6B embodiment, the resultant corrected anaglyph image may then have an anaglyph clipping procedure 662 applied in any appropriate manner to produce a final anaglyph image 620. For example, if the range of pixel values is selected to be from zero to 255, then the clipping procedure may remove any values that exceed the predetermined range. Additional details regarding the generation of anaglyph images are further discussed below in conjunction with FIGS. 7-9.

Referring now to FIG. 7, a diagram of a display screen 514 for performing a ghosting reduction procedure is shown, in accordance with one embodiment of the present invention. The FIG. 7 embodiment is presented for purposes of illustration, and in alternate embodiments, the present invention may reduce ghosting artifacts by utilizing techniques and configurations in addition to, or instead of, certain of those techniques and configurations discussed in conjunction with the FIG. 7 embodiment. The FIG. 7 display screen 514 may correspond to certain embodiments of step 418 of FIG. 4.

In the FIG. 7 embodiment, display screen 514 provides a ghosting reduction GUI which includes a test pattern 714 that is designed to allow a system user to visually evaluate ghosting characteristics of a displayed image. The FIG. 7 test pattern is presented for purposes of illustration, and in alternate embodiments, other test patterns may be configured in any effective manner.

The system user may utilize a slider bar 718 or any other effective means to adjust one or more ghosting parameters to minimize ghosting artifacts for a particular display 130. The selected parameter(s) may then be utilized to display anaglyph images on display 130. The ghosting parameters may include, but are not limited to, a spectrum shape and peak location, gamma characteristics, image contrast or left/right channel contrast, image sharpness, YUV color space components, and saturation in HSI or HSL color space.

One effective technique for reducing ghosting is to adjust the saturation component in Hue-Saturation-Intensity (HSI) color space, while keeping hue and intensity constant. Another effective method for reducing ghosting is to adjust the UV and Y values in YUV color space by two steps. In the first step, the Y value is adjusted, while keeping the UV value constant. The difference between the Y change ratio and the UV change ratio that produces minimal ghosting may then be utilized in step two. In the second step, the UV and Y values are adjusted together, while keeping the difference between the Y and the UV change ratio fixed. Finally, the Y and UV value combination that produce minimal ghosting may then recorded and utilized. The derivation and utilization of ghosting parameters are further discussed below in conjunction with FIG. 9.

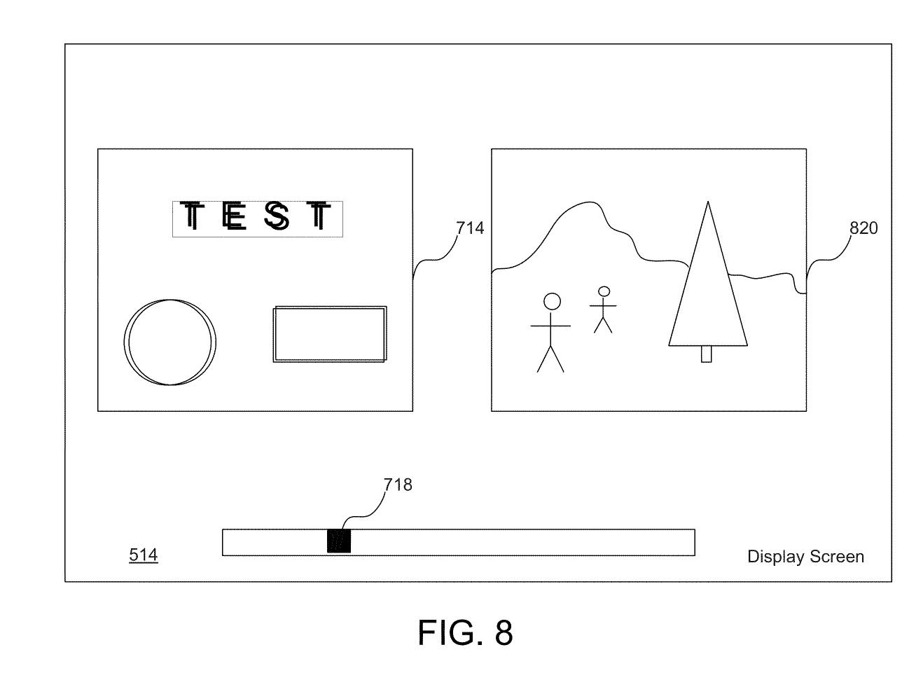

Referring now to FIG. 8, a diagram of a display screen 514 for performing a color adjustment procedure is shown, in accordance with one embodiment of the present invention. The FIG. 8 embodiment is presented for purposes of illustration, and in alternate embodiments, the present invention may adjust color parameters by utilizing techniques and configurations in addition to, or instead of, certain of those techniques and configurations discussed in conjunction with the FIG. 8 embodiment. The FIG. 8 display screen 514 may correspond to certain embodiments of step 420 of FIG. 4.

In the FIG. 8 embodiment, display screen 514 provides a color adjustment GUI which includes a test pattern 714 that is designed to allow a system user to evaluate ghosting characteristics of a displayed image. The FIG. 8 test pattern is presented for purposes of illustration, and in alternate embodiments, test patterns may be configured in any effective manner. In the FIG. 8 embodiment, the color GUI also includes a color scene that is designed to allow a system user to visually evaluate color characteristics of a displayed image. The FIG. 8 color scene is presented for purposes of illustration, and in alternate embodiments, color scenes may be configured in any effective manner. In certain embodiments, the color scene may typically include images of various colorful objects.

The system user may utilize a slider bar 718 or any other effective means to adjust one or more color parameters (and potentially ghosting artifacts of the test pattern) to provide an optimal trade off between the color characteristics and ghosting artifacts for a particular display 130. The color parameters may include, but are not limited to, spectrum shape and peak location, luminance weighting of left and right channels in transformation matrix generation, gamma characteristics, saturation and intensity in HSI color space, saturation and lightness in HSL color space, and chrominance and luminance in CIE L*a*b* color space or in YUV color space.

An effective HSI technique for optimizing color is to adjust the intensity component while keeping hue and saturation constant. An effective YUV method for optimizing color is to initially utilize the difference of adjustment ratios in Y and UV that is discussed above in conjunction with the FIG. 7 ghosting parameters. Both the Y channel and the UV channel may then be adjusted together. In certain embodiments, the foregoing HSI technique and the YUV method may be utilized either separately or in conjunction with each other. The derivation and utilization of color parameters are further discussed below in conjunction with FIG. 9.

Referring now to FIGS. 9A and 9B, a flowchart of method steps for performing an anaglyph image generation procedure is shown, in accordance with one embodiment of the present invention. The FIG. 9 flowchart is presented for purposes of illustration, and in alternate embodiments, the present invention may utilize steps and sequences other than those steps and sequences discussed in conjunction with the FIG. 9 embodiment.

In step 914 of FIG. 9A, a conversion manager 320 of an anaglyph generator 126 (FIG. 1) initially accesses an input left stereo pair image 614 in rgb color space. In step 918 the FIG. 9A embodiment, the input left image 614 has reverse gamma correction 650 applied to produce an uncorrected left image 652. In step 922, the uncorrected left image is then processed with a left transform matrix 654 that is previously derived in an offline procedure depending upon selected characteristics of the particular display 130. In certain embodiments, display type information may be provided by a system user to identify an effective specific display spectrum and/or other display characteristics for deriving the transform matrix. In step 926, the resultant transformed left image then has a left clipping procedure 656 applied in any appropriate manner to produce a clipped left image. For example, if the range of pixel values is selected to be from zero to 255, then the clipping procedure may remove any values that exceed the predetermined range.

In step 930 of FIG. 9A, the conversion manager 320 similarly accesses an input right stereo pair image 612 in rgb color space. In step 934, the input right image 612 has reverse gamma correction 642 applied to produce an uncorrected right image 644. In step 938, the uncorrected right image is then processed with a right transform matrix 646 that is previously derived in the offline procedure depending upon selected characteristics of the particular display 130. In certain embodiments, display type information may be provided by a system user to identify an effective specific display spectrum and/or other display characteristics for deriving the transform matrix. In step 942, the resultant transformed right image then has a right clipping procedure 648 applied in any appropriate manner to produce a clipped right image. For example, if the range of pixel values is selected to be from zero to 255, then the clipping procedure may remove any values that exceed the predetermined range.

In step 946, the foregoing clipped right image and clipped left image are combined to produce an initial anaglyph image. The FIG. 9A process then advances to step 950 of FIG. 9B through connecting letter “A”. In step 950, the conversion manager 320 may perform a ghosting reduction procedure on the initial anaglyph image according to one or more ghosting reduction parameters that have been previously defined in any appropriate manner. For example, a system user may empirically define specific ghosting reduction parameter(s) when viewing a ghosting test pattern 714 while adjusting the ghosting reduction parameter(s) to obtain a minimal amount of ghosting artifacts.

In step 954, the conversion manager 320 may perform a color adjustment procedure on the initial anaglyph image according to one or more color adjustment parameters that have been previously defined in any appropriate manner. For example, a system user may empirically define specific color adjustment parameter(s) when viewing a color scene in conjunction with the ghosting test pattern 714 while varying the color adjustment parameter(s) to obtain an optimal tradeoff between ghosting artifacts and color characteristics.

In step 958, the initial anaglyph image may have gamma correction 660 applied to produce a corrected anaglyph image. In step 962 of the FIG. 9B embodiment, the resultant corrected anaglyph image may then have a anaglyph clipping procedure 662 applied in any appropriate manner to produce a final anaglyph image 620. For example, if the range of pixel values is selected to be from zero to 255, then the clipping procedure may remove any values that exceed the predetermined range. Finally, in step 966, the final anaglyph image 620 may be viewed through 3D anaglyph glasses on the display 130. The FIG. 9 procedure may then terminate. For at least the foregoing reasons, the present invention therefore provides an improved system and method for efficiently generating device-dependent anaglyph images.

The invention has been explained above with reference to certain embodiments. Other embodiments will be apparent to those skilled in the art in light of this disclosure. For example, the present invention may readily be implemented using certain configurations and techniques other than those described in the specific embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for supporting an anaglyph image generation procedure, comprising:
a display device for presenting an anaglyph image in a three-dimensional format;
a conversion manager that interacts with a system user to perform a configuration procedure for generating said anaglyph image, said configuration procedure defining one or more imaging parameters that are dependent upon imaging characteristics of said display device; and
a processor that controls said conversion manager to perform said anaglyph image generation procedure.

2. The system of claim 1 wherein said conversion manager is separately implemented in an anaglyph converter device, said display device being implemented without anaglyph image generation capabilities.

3. The system of claim 1 wherein said imaging parameters include a device display type with corresponding display characteristics, one or more ghosting reduction parameters, and one or more color adjustment parameters.

4. The system of claim 1 wherein said system user utilizes a display-type GUI to identify particular display characteristics of said display device, said display characteristics being utilized to derive one or more transformation matrices for performing said anaglyph image generation procedure.

5. The system of claim 4 wherein said display characteristics include display spectrum characteristics of said display device.

6. The system of claim 1 wherein said system user utilizes a ghosting GUI to select one or more ghosting reduction parameters by adjusting and visually evaluating a ghosting test pattern, said one or more ghosting reduction parameters being utilized to minimize ghosting artifacts said anaglyph image.

7. The system of claim 5 wherein said one or more ghosting reduction parameters are adjusted by said system user with a slider bar on said ghosting GUI.

8. The system of claim 5 wherein said ghosting reduction parameters include a saturation parameter in a hue-saturation-intensity color space.

9. The system of claim 1 wherein said system user utilizes a color adjustment GUI to select one or more color adjustment parameters by adjusting and visually evaluating a color image in conjunction with a ghosting test pattern, said color adjustment parameters being utilized to minimize color artifacts in said anaglyph image.

10. The system of claim 9 wherein said one or more color adjustment parameters are adjusted by said system user with a slider bar on said color adjustment GUI.

11. The system of claim 9 wherein said color adjustment parameters include an intensity parameter in a hue-saturation-intensity color space.

12. The system of claim 3 wherein said conversion manager accesses an input left image, said conversion manager applying reverse gamma correction to said input left image, said conversion manager processing said input left image with a left transform matrix that is derived in an offline procedure based upon selected characteristics of said display device to produce a left transformed image.

13. The system of claim 12 wherein said conversion manager performs a left clipping procedure upon said left transformed procedure to produce a clipped left image.

14. The system of claim 13 wherein said conversion manager accesses an input right image, said conversion manager applying reverse gamma correction to said input right image, said conversion manager processing said input right image with a left transform matrix that is derived in said offline procedure based upon selected characteristics of said display device to produce a right transformed image.

15. The system of claim 14 wherein said conversion manager performs a right clipping procedure upon said right transformed procedure to produce a clipped right image.

16. The system of claim 15 wherein said conversion manager combines said clipped right image and said clipped left image to produce an initial anaglyph image.

17. The system of claim 15 wherein said conversion manager performs a ghosting reduction procedure on said initial anaglyph image according to said one or more ghosting reduction parameters that have been previously defined.

18. The system of claim 17 wherein said conversion manager performs a color adjustment procedure on said initial anaglyph image according to said one or more color adjustment parameters that have been previously defined.

19. The system of claim 17 wherein said conversion manager applies gamma correction to said initial anaglyph image to produce a corrected anaglyph image, said conversion manager then performing an anaglyph clipping procedure upon said corrected anaglyph image to produce a final version of said anaglyph image for viewing on said display device.

20. A method for supporting an anaglyph image generation procedure, by performing the steps of:
presenting an anaglyph image in a three-dimensional format on a display device;
utilizing a conversion manager that interacts with a system user to perform a configuration procedure for generating said anaglyph image, said configuration procedure defining one or more imaging parameters that are dependent upon imaging characteristics of said display device; and
controlling said conversion manager with a processor to perform said anaglyph image generation procedure.

21. The method of claim 20 wherein said conversion manager performs said configuration procedure automatically without interactions with said system user solely based on display properties and display types.

22. The method of claim 21 wherein preliminary testing with a single user or multiple users is performed in advance, and settings for the most popular televisions, displays, and projectors are stored in the processor memory.
